(19) United States
(12) Patent Application Publication
(10) Pub. No.: US 2004/0008103 A1
(43) Pub. Date: Jan. 15, 2004

(54) Vehicle security system

(75) Inventors: Mark A. Kady, Greentown, IN (US); Matthew W. Muddiman, Noblesville, IN (US); Blake E. Rollins, Russiaville, IN (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Delphi Technologies, Inc.

(21) Appl. No.: 10/195,613

(22) Filed: Jul. 15, 2002

(51) Int. Cl. H04Q 1/00; G05B 19/00

(52) U.S. Cl. 340/5.52; 340/5.53; 340/426.12

(57) ABSTRACT

A security system including a vehicle based security manager processor and a communications module linked to the security manager processor. The communications module is capable of communicating to a remote call center by way of an internet communication link. If certain security protocols are breached, the call center communicates a shutdown command to the vehicle by way of the internet communications link and the vehicle initiates a shutdown procedure for incapacitating the vehicle.

### TECHNICAL FIELD

The present invention generally relates to security systems and more particularly relates to vehicle security systems.

### BACKGROUND OF THE INVENTION

Existing vehicle security systems are primarily autonomous systems used to detect theft or vandalization of vehicle components or improper vehicle entry. More sophisticated vehicle security systems exist that provide some form of vehicle status information which is relayed back to a monitoring center. The OnStar® system provides the ability for a vehicle operator to electronically communicate via “voice communications” with someone manning a call center. These communications are typically used to verbally provide routing, and other navigational information to the vehicle operator. They are also used by the vehicle operator to communicate vehicle operational problems to the call center so that the appropriate assistance can be dispatched to the vehicle operator.

In view of the recent homeland security issues, protecting vehicles against theft or vandalism has become secondary giving way to a primary concern of protecting citizens from vehicles that could possibly be used for mass destruction of life. The present invention is particularly well suited to remotely disable any vehicle, especially a land based or aquatic based vehicle.

### BRIEF DESCRIPTION OF THE DRAWINGS

FIG. 1 is a diagrammatic view of the hardware and software building blocks used to implement the preferred embodiment of the disclosed vehicle security system.

FIG. 2 is a diagrammatic depiction used to discuss the various communication links and methods used by the security system of the present invention to communicate with and to disable the vehicle.

### DETAILED DESCRIPTION OF THE PREFERRED EMBODIMENTS

Security Hardware and Software

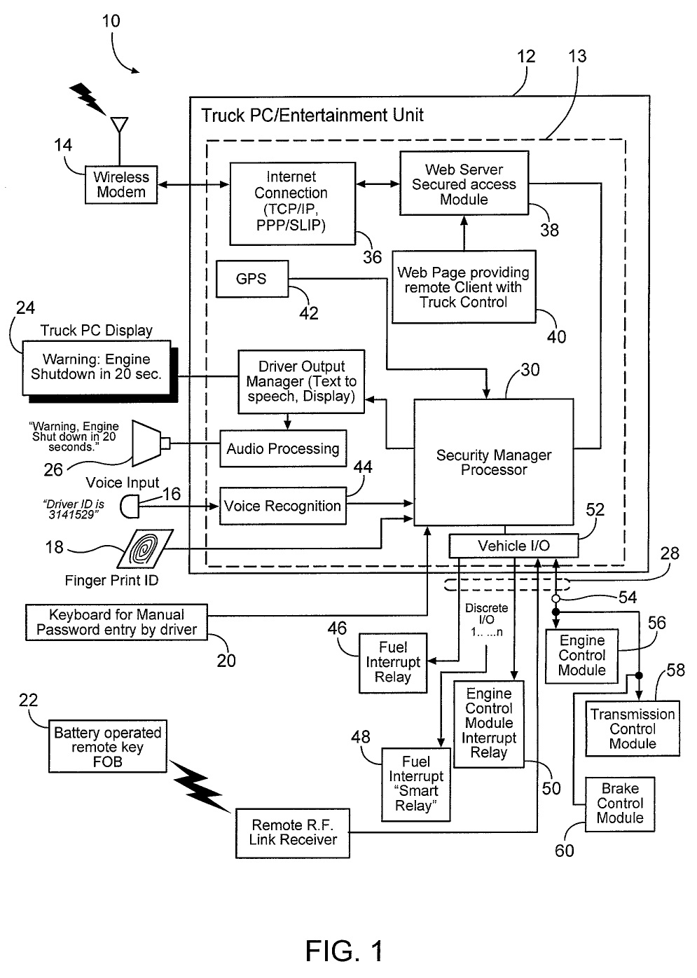

Now referring to FIG. 1, the security system 10 of the present invention is preferably mounted within truck PC/entertainment unit 12. Most modern trucks typically employ a PC/entertainment unit 12 mounted in the dash of the truck. The entertainment unit typically includes a radio, CD player, two-way radio, and the like. The security system 10 of the present invention (particularly the security functionality module 13 portion of security system 10), is particularly well suited to be integrated into the truck PC/entertainment unit 12, thereby yielding a unitary package. Although the preferred embodiment of the present invention is to install the security system 10 inside the truck PC/entertainment unit 12, it is to be understood that the security system 10 (including module 13) can function equally well as a stand alone unit sold on new vehicles or as a retrofit unit sold for installation on existing vehicles. Additionally, although it is envisioned that the security system 10 of the present invention will be particularly well suited to be placed on trucks carrying potentially hazardous materials, the present invention is not limited to trucks, but is also well suited to any land based or water based vehicle where security monitoring or remote disablement is desirable. Because the present invention is particularly well suited for the heavy truck and hauling industry, much of the discussion herein is particularly applicable to the trucking industry. However, as stated above, nothing in this disclosure should be deemed to limit this disclosure to the trucking industry.

The primary preferred inputs to the security functionality module 13 include wireless modem link 14, GPS link 42, voice input link 16, finger print ID link 18, keyboard input link 20, and battery operated remote link 22. The primary outputs from the security functionality module 13 include truck PC display device 24, and audio output device 26. Additional input/output paths (I/O) allow security functionality module 13 to interface directly with various hardware components of the vehicle engine, transmission, and fuel delivery system.

The heart of security functionality module 13 is the security manager processor 30. In its preferred embodiment, security manager processor is implemented by way of a dedicated microprocessor; however, other implementations are possible such as a hardware implementation. Detail explanation of the functions carried out by security functionality module 13 are set forth below in conjunction with the various modes of operation capable of implementation by the security system 10 of the present invention.

Security Modes

The following describes four preferred security modes the security system 10 of the present invention is capable of implementing. The majority of these modes include disabling the truck in a secure manner thereby preventing unauthorized use of the vehicle. In cases where the truck is transporting dangerous substances, the security system 10 will eliminate, or substantially impede, any attempts to steal or misuse the vehicle.

Reported Theft Security Method

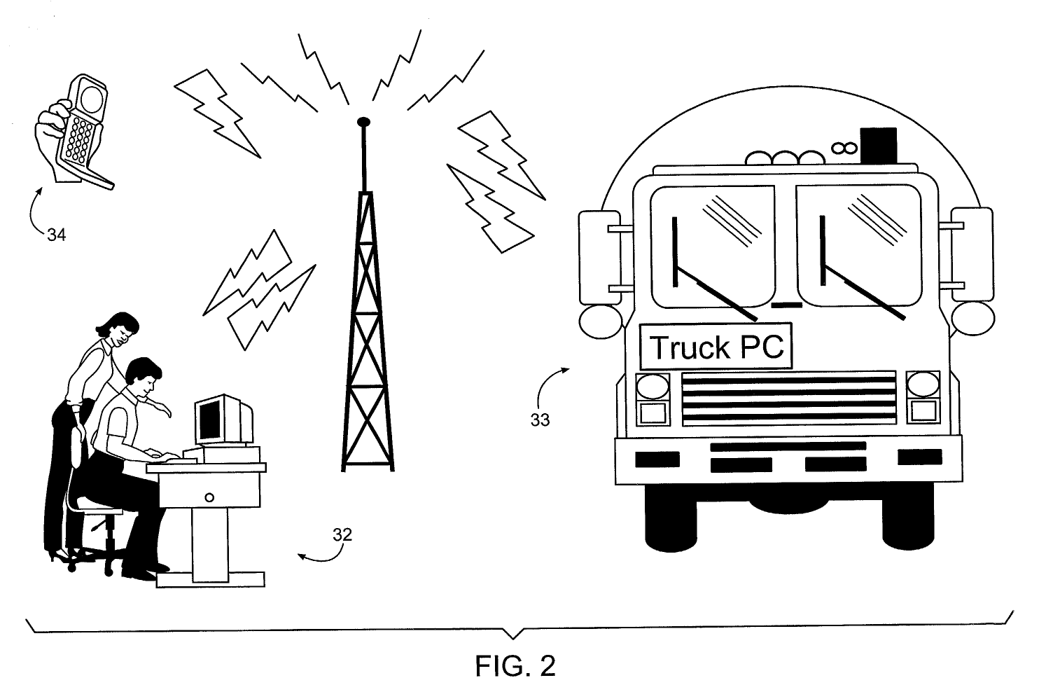

In this scenario, the vehicle driver reports the theft of the vehicle 33 to the call center 32 (see FIG. 2). As shown in FIG. 2, this method of communication between the vehicle operator and the call center 32 would, in most instances, take place over a conventional telephone communication line 34. Thereafter, the call center communicates with the appropriate vehicle 33 using the IP address assigned to that particular vehicle's truck PC system and enters the appropriate password using an internet browser Secure Socket Layer (SSL) Session 38. The security functionality module 13- is capable of receiving and sending internet communications by virtue of wireless modem 14, internet connection module 36, web server secured access module 38, and web page provider module 40. Upon receipt of the correct password, the security manager processor 30 serves a web page to call center 32 by way of web page provider module 40. The served web page gives various system options to the call center operators, one of which is the shut down option. If the operators 32 select the shut down option, the security manager processor requests confirmation from the call center by requesting a vehicle shutdown password. Upon receiving a valid password, the security manager processor 30 initiates a shut down sequence allowing time for the driver to move to a safe parking area (see Safety Considerations below).

Route Tracking Security Mode

Tracking of the vehicle using periodic GPS (Global Positioning System) transmission by way of a wireless internet connection is possible by virtue of using modules 36, and 38 in conjunction with security manager processor 30 and global position sensor module 42. Specifically, global positioning sensor module 42 receives global positioning signals and translates those into position information which is sent to security manager 30 for processing and communicating to call center 32 by way of modules 36, 38, and wireless modem 14 (as has already been described above). It is contemplated that in the route tracking security mode, a route is pre-programmed into the security manager processor so either manually (by way of keyboard 20) or remotely by way of the internet. If the truck 33 deviates from this programmed route by more than a predetermined distance (the predetermined distance is preferably determined by the call center 32), the security manager processor 30 notifies the call center 32. The call center 32 would then prompt the vehicle operator to input a password in order to permit continued operation of the vehicle. If the password is not entered, or entered incorrectly, the call center could initiate vehicle shutdown immediately, or within a programmed period of time (e.g. five minutes).

Periodic Driver Authentication Security Mode

Under this methodology, driver authentication is conducted either periodically or every ignition cycle by the driver entering an identification number. A technique of required periodic entry of an ID number guarantees that the driver is authenticated even when remote communications are not possible and the vehicle is not being tracked. For example, it may be that wireless coverage does not exist during a significant portion of the vehicle's route. The periodic entry of the driver ID ensures that the driver is the driver authorized to operate the vehicle. This ID can be either fixed, changed periodically by call center 32, or changed automatically by the security manager processor 30 based on a shared “rolling code” algorithm. The implementation of a “rolling code” algorithm requires the truck driver to have a means for obtaining new ID's based on time (e.g. a secure ID). This ID would be a function of time and the vehicle ID:

ID=function (t, vehicle ID)

where the function is a standard crypto-rolling code to be determined. The ID can be entered either by way of the keyboard 20 or via a voice input 16 which is processed by voice recognition module 44. ID input by way of voice is the preferred mode of data input by the vehicle driver because it promotes greater levels of safety by allowing the vehicle operator to communicate with security system 10 while still keeping his “eyes on the road.” In normal situations, when there is a low level security alert status, the security manager processor 30 may only require driver ID verification every 2-4 hours. This infrequent ID request will have minimal impact on the driver's normal driving routine; however, in times when the nation is put on high alert, call center 32 can require more frequent verification of driver ID (perhaps as frequently as every fifteen minutes or so). This increased level of driver inconvenience is offset by the need of greater diligence during times of “high alert” status. The internet connectivity of security system 10, permits this kind of dynamic behavior.

It is also contemplated that the driver authentication could be done electronically (e.g. by way of a short range, wireless link or ID card that the driver keeps on his person). Other techniques of driver verification include finger print ID recognition 18 and voice signature recognition techniques (voice signature recognition techniques not shown).

Alarm Security Mode

In the event of a hijack attempt, the truck driver can press an alarm button on keyboard 20 or manually activate a panic button on a remote key FOB transmitter 22. A remote transmitter 22 could also be used to immediately enable the security features of the truck thereby requiring re-entry of the driver ID before the vehicle could be operated. In the alarm security mode, the personnel of call center 32 would be immediately notified via the internet link 14, 36, 38 that a problem occurred.

Deactivation Methods

It is contemplated that in the preferred embodiment of the present invention, the following event would lead to a vehicle deactivation—wireless deactivation (initiated by call center 32), incorrect entry of a periodic password by the truck driver, incorrect entry of a password needed for a route deviation, or manual deactivation by the driver (either by way of battery operated remote 22 or keyboard input 20). After any one of the vehicle deactivation events described above, the security manager processor 30 would initiate a truck shutdown sequence. This sequence would lead to one or more of the following events:

1. Deactivation of relays 46, 48, or 50 using discreet I/O lines 28 from vehicle port 52 of security manager processor 30. The relays 46-50 can function in any number of manner to interrupt engine operation including immediately ceasing or gradually decreasing fuel flow to the engine (relay 46); commanding engine control module interrupt relay 50 to interrupt engine spark; or the use of a “smart relay” 48 which periodically must receive a “keep alive” signal from security manager processor 30 in order to prevent it from interrupting the engine fuel supply (see Tamper Resistance below for detailed information). Although a simple fuel interrupt relay 46 is easy to implement (especially when retrofitting existing vehicles), a “smart relay” 48 system is superior to a simple fuel interrupt relay 46 in that any incapacitation of security manager processor 30 automatically causes fuel interrupt “smart relay” 48 to engage and cease fuel flow to the engine.

2. Signals 54 can also be used to incapacitate transmission controllers 58 or brake controllers 60 resulting in disabling the vehicle (preventing the transmission to be moved from neutral) or applying the brakes, etc. Signals sent along communication path 28 can be dedicated I/O lines for each module 46, 38, 50. Signals sent along line 54 for each module, 56, 58, 60, are preferably serial communication along serial communication bus 54 to communicate with engine control module 56, transmission control module 58, or brake control module 60 to immobilize the vehicle. This could be done on an OEM type installation where the ECM transmission control module types are known before installation.

Safety Considerations

There are two main safety scenarios to be considered when designing a forced vehicle shutdown protocol. The first is when the vehicle is transporting hazardous/dangerous cargo and the second is when the vehicle cargo is not dangerous and can be shut down without call center 30 interaction. In the second case, it is important to give the vehicle operator proper and ample notification of vehicle shutdown in order to allow enough time for the driver to pull over into a safe area to park the vehicle. The security manager processor 30 will provide an audible message by way of audio output device 26 to the vehicle operator. This message indicates a security alert and that the vehicle is going to shut down in forty-five seconds (or the like). The audio system allows for alert messages of high priority to override power, volume, or other audio sources that might be competing for the use of audio output device 26. Thus it will be ensured that the driver receives the highest priority alert message. Once a shutdown command is received from call center 32 (or from security manager processor 30), an audio message will continue to countdown from the maximum alert time (which is programmable) to a five to ten second warning to a final vehicle shutdown. Once the countdown begins, nothing can be done to prevent vehicle shutdown. The sequence of audible shutdown messages would originate from the security manager processor 30 to prevent unauthorized users from preventing the vehicle shutdown by disabling the wireless communication system (e.g. removal of an antenna or other receiving device). In the first case, when there is hazardous/dangerous cargo at issue, it may be desirable to disable a vehicle only when local authorities indicate to the call center 30 that it is safe to do so.

Tamper Resistance

To prevent the security system from being susceptible to tampering, “smart relays” 48 can be used that require periodic (every fifteen to thirty seconds) commands from security manager processor 30 via vehicle I/O 52. These data commands would be messages that can either be fixed or a rolling code that changes periodically. “Smart relay” 48 would compare the received code to the expected code and if matched, would continue normal operation. If the security manager processor 30 were removed, destroyed, or otherwise interrupted (such as caused by cutting the wiring), the “smart relay” 48 would activate automatically thereby shutting down the vehicle. In an OEM type installation, the engine control module 56, or transmission control module 58, or brake control module 60 can be modified to expect a periodic message from the security manager processor 30 that indicates that the security manager processor 30 is still connected. Like the message received by the “smart relay” 48, the message received by the engine control module 56, the transmission control module 58, or brake control module 60 can be either a fixed data message or a rolling code message that changes periodically.

The foregoing detailed description shows that the preferred embodiments of the present invention are well suited to fulfill the object of the invention. It is recognized, however, that those skilled in the art may make various modifications or additions to the preferred embodiments chosen here to illustrate the present invention, without departing from the spirit of the present invention. Accordingly, it is to be understood that the coverage sought to be afforded hereby should be deemed to extend to the subject matter defined in the appended claims, including all fair equivalents thereof.

We claim:

1. A security system, comprising:
a vehicle based security manager processor a communications module linked to said security manager processor, wherein said communications module is capable of communicating to a remote call center by way of an internet communications link,
wherein said security manager processor includes means for acting on a shutdown command from said call center, and means for incapacitating said vehicle.

2. The security system of claim 1, wherein said security manager processor is contained within a vehicle entertainment system.

3. The security system of claim 1, wherein said communications module includes a wireless modem.

4. The security system of claim 1, wherein said communications module includes an internet connection module.

5. The security system of claim 4, wherein said communications module further includes a web server secured access module.

6. The security system of claim 5, wherein said communications module further includes a web page provider module.

7. The security system of claim 1, wherein said security system further includes at least one of a voice input link, fingerprint ID link, or a keyboard input link coupled to said security manager processor.

8. The security system of claim 1, wherein said security manager processor is coupled to a fuel relay of said vehicle.

9. The security system of claim 1, wherein said security manager processor is coupled to a smart relay.

10. The security system of claim 1, wherein said security manager processor is coupled to an engine control module interrupt relay.

11. The security system of claim 1, wherein said security manager processor is coupled to an engine control module.

12. The security system of claim 1, wherein said security manager processor is coupled to a transmission control module.

13. The security system of claim 1, wherein said security manager processor is coupled to a brake control module.

14. The security system of claim 1, wherein said security manager processor is coupled to a remote R.F. link receiver.

15. Method of incapacitating a vehicle, comprising the steps of:
a) receiving a command in a call center that a vehicle has deviated from a predetermined protocol,
b) sending from said call center, by way of a wireless communication, a shut down command to a security system mounted in said vehicle,
c) conducting a shut down procedure whereby said vehicle is incapacitated.

16. The method of claim 15, wherein step b) is conducted over the internet by way of a wireless modem.

17. The method of claim 16, wherein step a) includes receiving a communication from a vehicle operator.

18. The method of claim 16, wherein step a) includes receiving a communication from a Global Position Sensor mounted in said vehicle.

19. The method of claim 18, wherein said Global Position Sensor communication takes place over the internet.

20. The method of claim 15, wherein said predetermined protocol includes downloading vehicle routing information to said call center.

21. The method of claim 15, wherein said predetermined protocol includes downloading vehicle routing information to said vehicle security system.

22. The method of claim 20, further including the step of comparing said downloaded vehicle routing information with information collected by a Global Positing system mounted in the vehicle.

23. The method of claim 21, further including the step of comparing said downloaded vehicle routing information with information collected by a Global Positing system mounted in the vehicle.

24. Method of incapacitating a vehicle, comprising the steps of:
a) receiving a signal initiated by the vehicle driven,
b) checking the validity of the signal according to a predetermined protocol,
c) incapacitating the vehicle if the checking of step b) violates the terms of the predetermined protocol.

25. The method of claim 24, wherein said signal is initiated by said driver by way of using an ID remote transmitter FOB.

26. The method of claim 24, wherein said signal is initiated by said driver by way of using an input device to input an ID number.

27. The method of claim 26, wherein said ID number is reassigned from time to time using a rolling code algorithm.

28. The method of claim 27, wherein said rolling code algorithm is administered by a call center remote from said vehicle.

29. The method of claim 27, wherein said rolling code algorithm takes into account time and vehicle ID.

30. The method of claim 24, wherein the received signal is initiated by the driver using a battery operated wireless transmitter.

30. The method of claim 24, wherein incapacitating the vehicle includes preventing fuel to flow to the vehicle engine.

31. The method of claim 24, wherein incapacitating the vehicle includes incapacitating the transmission of the vehicle.

32. The method of claim 24, wherein incapacitating the vehicle includes causing a brake system of the vehicle to apply the vehicle brakes.
